(19) United States
(12) Patent Application Publication
(10) Pub. No.: US 2026/0120662 A1
(43) Pub. Date: Apr. 30, 2026

(54) SHIFT REGISTER, DISPLAY DEVICE, AND METHOD OF DRIVING SHIFT REGISTER

(71) Applicant: Sharp Display Technology Corporation, Kameyama City (JP)

(72) Inventors: Hiroyuki ADACHI, Kameyama City (JP); Yuhichiroh MURAKAMI, Kameyama City (JP); Shige FURUTA, Kameyama City (JP); Yasushi SASAKI, Kameyama City (JP); Nami NAGIRA, Kameyama City (JP); Takahiro YAMAGUCHI, Kameyama City (JP); Kohei HOSOYACHI, Kameyama City (JP)

(21) Appl. No.: 19/363,793

(22) Filed: Oct. 21, 2025

(30) Foreign Application Priority Data
Oct. 24, 2024 (JP) 2024-187747

(51) Int. Cl. G09G 3/36; G06F 3/041

(52) U.S. Cl. CPC G09G 3/3677; G06F 3/0418; G09G 2300/0819; G09G 2300/0842; G09G 2310/0286; G09G 2310/08; G09G 2330/021; G09G 2354/00

(57) ABSTRACT

A shift register according to the present disclosure includes a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, and a third transistor whose gate terminal is connected to the first node, in which each of the unit circuits includes a third circuit, the second node is connected to a first power supply via the third transistor and the third circuit, and a control signal is input to the third circuit.

### CROSS-REFERENCE TO RELATED APPLICATIONS

This application claims the benefit of priority to Japanese Patent Application Number 2024-187747 filed on Oct. 24, 2024. The entire contents of the above-identified application are hereby incorporated by reference.

### BACKGROUND

### Technical Field

The disclosure relates to a shift register and the like.

FIG. 33 is a circuit diagram illustrating a unit circuit of a shift register of the related art. In the unit circuit of FIG. 33, during a reset operation, a period may occur in which transistors 103 and 108 are turned on simultaneously.

### SUMMARY

In a shift register of the related art, a problem may occur in which a high-potential power supply and a low-potential power supply are short-circuited during a reset operation.

A shift register according to one aspect of the disclosure includes a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, and a third transistor whose gate terminal is connected to the first node, in which each of the plurality of unit circuits includes a third circuit, the second node is connected to a first power supply via the third transistor and the third circuit, and a control signal is input to the third circuit.

This eliminates a problem in which a high-potential power supply and a low-potential power supply are short-circuited during a reset operation.

### BRIEF DESCRIPTION OF DRAWINGS

The disclosure will be described with reference to the accompanying drawings, wherein like numbers reference like elements.

FIG. 1 is a circuit diagram illustrating the configuration of a unit stage of a shift register according to the present embodiment.

FIG. 2 is a block diagram illustrating the configuration of this shift register.

FIG. 3 is a timing chart illustrating a plurality of input signals for this shift register.

FIG. 4 is a timing chart illustrating the operation of this shift register.

FIG. 5 is a cross-sectional view illustrating an example of the configuration of a liquid crystal panel according to the present embodiment.

FIG. 6 is a schematic plan view illustrating an example of the configuration of a display device according to the present embodiment.

FIG. 7 is a circuit diagram illustrating an example of the configuration of a subpixel of the display device according to the present embodiment.

FIG. 8 is a schematic plan view illustrating an example of the configuration of a counter electrode of the display device according to the present embodiment.

FIG. 9 is a timing chart illustrating the operation of the display device according to the present embodiment.

FIG. 10 is a block diagram illustrating the configuration of this shift register.

FIG. 11 is a timing chart illustrating a plurality of input signals for this shift register.

FIG. 12 is a circuit diagram illustrating the configuration of the unit stage of the shift register according to the present embodiment.

FIG. 13 is a circuit diagram illustrating the configuration of the unit stage of the shift register according to the present embodiment.

FIG. 14 is a circuit diagram illustrating the configuration of the unit stage of the shift register according to the present embodiment.

FIG. 15 is a timing chart illustrating the operation of this shift register.

FIG. 16 is a block diagram illustrating the configuration of this shift register.

FIG. 17 is a circuit diagram illustrating the configuration of a unit stage in FIG. 16.

FIG. 18 is a timing chart illustrating the operation of this shift register.

FIG. 19 is a block diagram illustrating the configuration of this shift register.

FIG. 20 is a circuit diagram illustrating the configuration of the unit stage in FIG. 19.

FIG. 21 is a block diagram illustrating the configuration of this shift register.

FIG. 22 is a circuit diagram illustrating the configuration of the unit stage in FIG. 20.

FIG. 23 is a circuit diagram illustrating the configuration of the unit stage in FIG. 20.

FIG. 24 is a timing chart illustrating the operation of a display device that performs touch detection.

FIG. 25 is a block diagram illustrating the configuration of this shift register.

FIG. 26 is a timing chart illustrating a plurality of input signals for this shift register.

FIG. 27 is a circuit diagram illustrating the configuration of the unit stage in FIG. 25.

FIG. 28 is a timing chart illustrating the operation of this shift register.

FIG. 29 is a timing chart illustrating the operation of this shift register.

FIG. 30 is a block diagram illustrating the configuration of this shift register.

FIG. 31 is a circuit diagram illustrating the configuration of the unit stage in FIG. 30.

FIG. 32 is a timing chart illustrating the operation of this shift register.

FIG. 33 is a circuit diagram illustrating a unit circuit of a shift register of the related art.

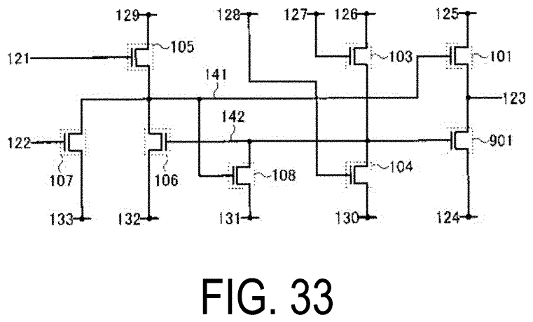

### DESCRIPTION OF EMBODIMENTS

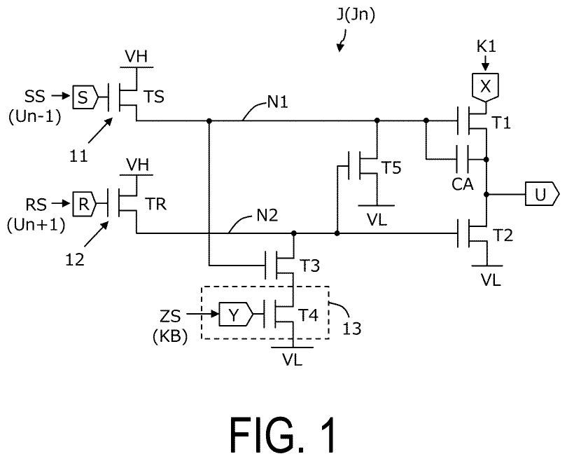

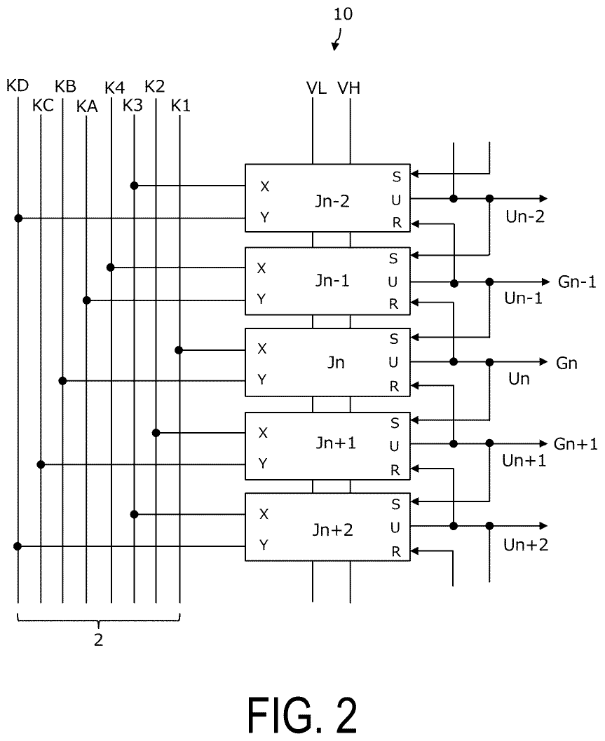

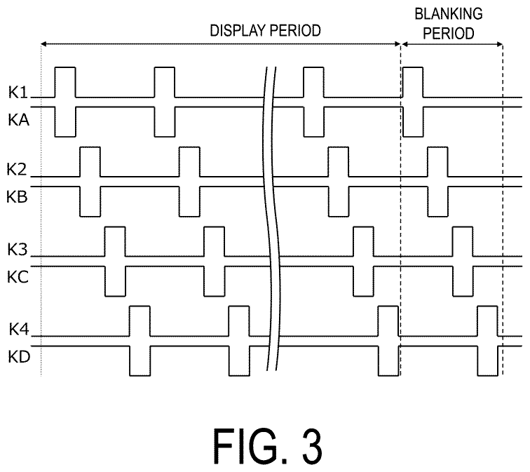

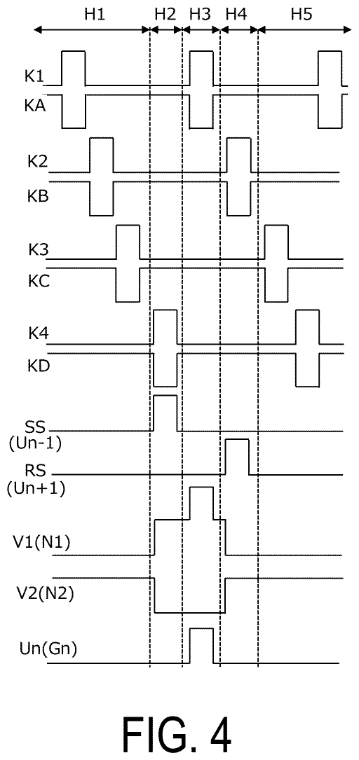

FIG. 1 is a circuit diagram illustrating the configuration of a unit stage of a shift register according to the present embodiment. FIG. 2 is a block diagram illustrating the configuration of this shift register. FIG. 3 is a timing chart illustrating a plurality of input signals to this shift register. FIG. 4 is a timing chart illustrating the operation of this shift register. As illustrated in FIGS. 1 to 4, a shift register 10 includes a plurality of unit circuits (Jn−2, Jn−1, Jn, Jn+1, and the like), and each unit circuit J includes a first circuit 11 to which a set signal SS is input, a second circuit 12 to which a reset signal RS is input, a first transistor T1, a second transistor T2, a first node N1 connected to a gate terminal of the first transistor T1, a second node N2 connected to a gate terminal of the second transistor T2, and a third transistor T3 whose gate terminal is connected to the first node N1. Each unit circuit J includes a third circuit 13, and the second node N2 is connected to a first power supply VL (for example, a low-potential power supply) via a third transistor T3 and the third circuit 13, and a control signal ZS is input to the third circuit 13.

In the shift register 10, the connection state between the second node N2 and the first power supply VL can be controlled by the third circuit 13 to which the control signal ZS is input. Thus, it is possible to eliminate a problem that the first power supply VL (for example, a low-potential power supply) and a second power supply VH (for example, a high-potential power supply) are short-circuited during a reset operation (for example, immediately after a reset signal RS is activated).

As illustrated in FIG. 1, the third circuit 13 includes a fourth transistor T4, the second node N2 is connected to the first power supply VL via the third transistor T3 and the fourth transistor T4, and the control signal ZS is input to a gate terminal Y of the fourth transistor T4.

As illustrated in FIG. 1, the first circuit 11 may include a set transistor TS having a gate terminal S (hereinafter, terminal S) to which a set signal SS is input and which is connected to the first node N1 and the second power supply VH. The second circuit 12 may include a reset transistor TR having a gate terminal R (hereinafter, terminal R) to which the reset signal RS is input and which is connected to the second node N2 and the second power supply VH. The unit circuit J may include a fifth transistor T5 having a gate terminal connected to the second node N2, and the first node N1 may be connected to the first power supply VL via the fifth transistor T5. The plurality of transistors (T1 to T5, TS, TR) included in each unit circuit J may be of the same type (for example, N-channel type).

As illustrated in FIG. 1, each unit circuit J includes a capacitance element CA, and one conduction terminal (output terminal U) of the first transistor T1 may be connected to the gate terminal of the first transistor T1 via the capacitance element CA. The first circuit 11 and the second circuit 12 may each be connected to the second power supply VH (for example, high-potential power supply). For example, the first node N1 may be connected to the second power supply VH via the set transistor TS of the first circuit 11, and the second node N2 may be connected to the second power supply VH via the reset transistor TR of the second circuit 12.

As illustrated in FIG. 2 and FIG. 3, the shift register 10 may be connected to a wiring group 2 through which clock signals (K1 to K4, KA to KD) are transmitted. The clock signals (K1 to K4, KA to KD) of a plurality of phases may be input to a plurality of unit circuits (Jn−2, Jn−1, Jn, Jn+1, and the like) of the shift register 10, one of the clock signals of the plurality of phases may be input to the other conduction terminal X (hereinafter, terminal X) of the first transistor T1, and the other conduction terminal (for example, source terminal) of the second transistor T2 may be connected to the first power supply VL. Each unit circuit J may include an output terminal U connected to one conduction terminal (for example, source terminal) of the first transistor T1 and one conduction terminal (for example, drain terminal) of the second transistor T2. For example, an output terminal U of a unit circuit Jn in an nth stage outputs an output signal Un (for example, scanning signal).

As illustrated in FIGS. 3 and 4, the phase of the clock signal K2 is delayed by 1H (horizontal scanning period) relative to the phase of the clock signal K1, the phase of the clock signal K3 is delayed by 1H relative to the phase of the clock signal K2, and the phase of the clock signal K4 is delayed by 1H relative to the phase of the clock signal K3. The clock signal KA has an opposite phase to the clock signal K1, the clock signal KB has an opposite phase to the clock signal K2, the clock signal KC has an opposite phase to the clock signal K3, and the clock signal KD has an opposite phase to the clock signal K4.

For the clock signals K1 to K4, a “High” period (a pulse formation period from a rise to a fall of a potential) may be referred to as an active period, and for the clock signals KA to KD, a “Low” period (a pulse formation period from a fall to a rise in potential) may be referred to as an active period. An active period (pulse width) of each clock signal may be 1H or less.

As illustrated in FIGS. 1 to 4, in the unit circuit Jn−1 in the n−1th stage, the set signal SS input to the terminal S is an output signal Un−2 in an n−2th stage, the reset signal RS input to the terminal R is an output signal Un in an nth stage, the clock signal K4 is input to the terminal X (input terminal), and the clock signal KA is input to the terminal Y as a control signal ZS. In the unit circuit Jn in the nth stage, the set signal SS input to the terminal S is an output signal Un−1 in the n−1th stage, the reset signal RS input to the terminal R is an output signal Un+1 in an n+1th stage, the clock signal K1 is input to the terminal X (input terminal), and the clock signal KB is input to the terminal Y as a control signal ZS. In the unit circuit Jn+1 in the n+1th stage, the set signal SS input to the terminal S is the output signal Un in the nth stage, the reset signal RS input to the terminal R is an output signal Un+2 in an n+2th stage, the clock signal K2 is input to the terminal X (input terminal), and the clock signal KC is input to the terminal Y as a control signal ZS.

In this manner, in the shift register 10, the set signal SS is an output signal in the previous stage, the reset signal RS is an output signal in the next stage, the four-phase clock signals K1 to K4 are input to terminals X of unit circuits in four consecutive stages, and the four-phase clock signals KA to KD are input to terminals Y of the unit circuits in the four consecutive stages.

As illustrated in FIG. 4, during a period H1, the pulses of the clock signals K1, K2, and K3 are output sequentially from the unit circuits in the n−4th to n−2th stages. During a period H2, the output signal Un−1 including the pulse of the clock signal K4 is output from the unit circuit Jn−1 (previous stage), and the pulse of the output signal Un−1, which is the set signal SS, is input to the set transistor TS of the unit circuit Jn (current stage). For this reason, the set transistor TS is turned on, the potential V1 of the first node N1 rises to “High”, the first transistor T1 is turned on, and the third transistor T3 and the fourth transistor T4 are both turned on (the clock signal KB is High during the period H2). Thereby, the potential V2 of the second node N2 falls to “Low”, and the second transistor T2 is turned off. During a period H3, the potential of the clock signal K1 input to the terminal X (the conduction terminal of the first transistor T1) rises, and thus the potential V1 of the first node N1 is bootstrapped by the capacitance element CA, and the output signal Un including the pulse of the clock signal K1 is output from the unit circuit Jn (current stage).

During a period H4, the output signal Un+1 including the pulse of the clock signal K2 is output from the unit circuit Jn+1 (next stage), and the pulse of the output signal Un+1, which is the reset signal RS, is input to the reset transistor TR of the unit circuit Jn (current stage). For this reason, the reset transistor TR is turned on, the potential V2 of the second node N2 rises to “High”, the second transistor T2 and the fifth transistor T5 are turned on, and the first transistor T1 is turned off. Thereby, the output terminal U is connected to the first power supply VL, the output signal Un is fixed to a “Low” potential, and the reset operation is completed. During a period H5, the pulses of the clock signals K3 and K4 are output sequentially from the unit circuits in the n+2th and n+3th stages.

The clock signal KB, which is the control signal ZS of the current stage (unit circuit Jn), has an opposite phase to the clock signal K2 input to the next stage (unit circuit Jn+1), and thus, the fourth transistor T4 is turned off during a period in which the reset transistor TR is turned on during the period H4, and the second node N2 is insulated from the first power supply VL. In other words, it is possible to avoid a problem that the first power supply VL and the second power supply VH are short-circuited via the third transistor T3 and the reset transistor TR during a reset operation (a period during which the reset transistor TR is turned on).

In this shift register 10, as illustrated in the period H4, the control signal ZS (clock signal KB) and the reset signal RS may be in an opposite phase relationship during a period in which the reset signal RS is in an active state. Furthermore, as illustrated in the period H2, during an active period of the set signal SS, the fourth transistor T4 may be turned on (KB is High) by the control signal ZS (clock signal KB). Thereby, the potential V1 of the first node N1 and the potential V2 of the second node N2 can be stably in opposite phases.

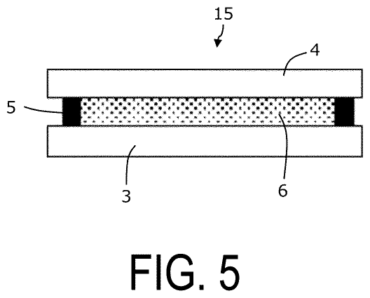

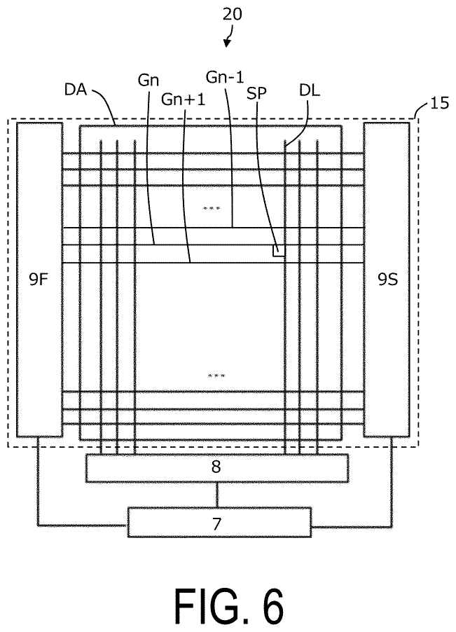

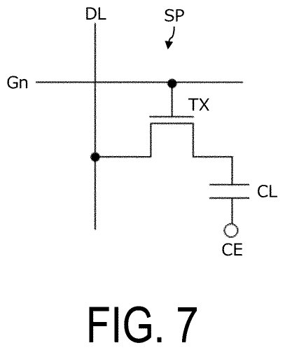

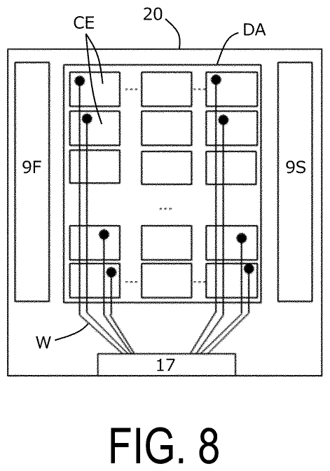

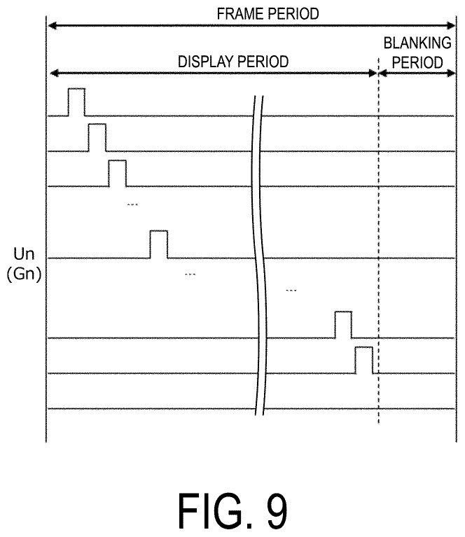

FIG. 5 is a cross-sectional view illustrating an example of the configuration of a liquid crystal panel according to the present embodiment. FIG. 6 is a schematic plan view illustrating an example of the configuration of a display device. FIG. 7 is a circuit diagram illustrating an example of the configuration of a subpixel of this display device. FIG. 8 is a schematic plan view illustrating an example of the configuration of a counter electrode of this display device. FIG. 9 is a timing chart illustrating the operation of this display device. As illustrated in FIG. 5, a liquid crystal panel 15 may include an active matrix substrate 3, a counter substrate 4, and a liquid crystal layer 6 surrounded by the active matrix substrate 3, the counter substrate 4, and a seal 5.

As illustrated in FIG. 6, a display device 20 may include a display unit DA, a data driver 8, scanning drivers 9F and 9S, and a control circuit 7 that controls each driver. The display unit DA may be provided with a plurality of data lines DL, a plurality of scanning lines Gn and Gn−1, and a plurality of subpixels SP. The scanning drivers 9F and 9S may include a shift register 10. A wiring group 2 in FIG. 2 may be connected to the control circuit 7.

This display device 20 may include the liquid crystal panel 15, and the scanning drivers 9F and 9S may be formed integrally with the active matrix substrate 3 or may be formed in a driver IC separate from the active matrix substrate 3.

As illustrated in FIG. 7, the subpixel SP may include a pixel transistor TX having a gate terminal connected to the scanning line Gn, and a liquid crystal capacitor CL. The liquid crystal capacitor CL may include a pixel electrode PE and a counter electrode CE. The pixel electrode PE may be connected to a data line DL via the pixel transistor TX. As illustrated in FIG. 8, a plurality of counter electrodes CE may be disposed in the display unit DA, and each counter electrode CE may be connected to a counter electrode driver 17 via a wiring W. As illustrated in FIG. 9, a frame period of the display device 20 may include a display period in which the shift register 10 performs a shift operation, and a blanking period in which the shift register 10 does not perform a shift operation.

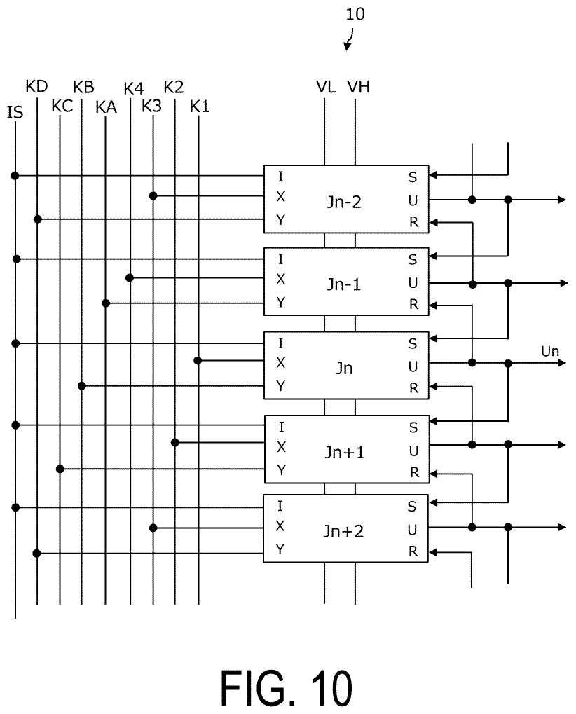

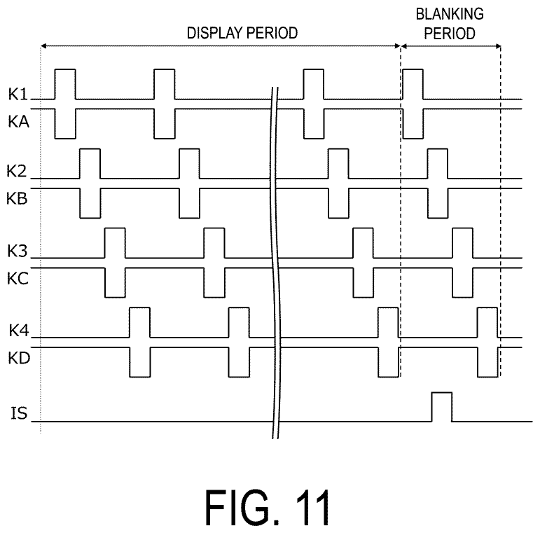

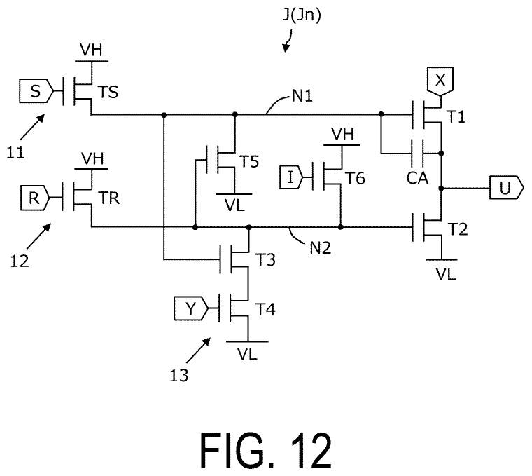

FIG. 10 is a block diagram illustrating the configuration of this shift register. FIG. 11 is a timing chart illustrating a plurality of input signals for this shift register. FIGS. 12 to 14 are circuit diagrams illustrating the configuration of a unit stage of a shift register according to the present embodiment. As illustrated in FIGS. 10 to 14, in the shift register 10, the unit circuit J may include a sixth transistor T6 in which an initialization signal IS is input to its gate terminal (terminal I), and the second node N2 may be connected to the second power supply VH via the sixth transistor T6. The initialization signal IS is set to be in an inactive “Low” state during a display period and is set to be in an active “High” state during a blanking period, and thus the second node N2 is connected to the second power supply VH during the blanking period to stably keep the second transistor T2 in an ON state and maintain the potential of the output signal Un at “Low”.

In the unit circuit Jn in an nth stage illustrated in FIGS. 12 to 14, the set signal SS input to the terminal S is the output signal Un−1 in the n−1th stage, the reset signal RS input to the terminal R is the output signal Un+1 in the n+1th stage, the clock signal K1 is input to the terminal X (input terminal), and the clock signal KB is input to the terminal Y as a control signal ZS.

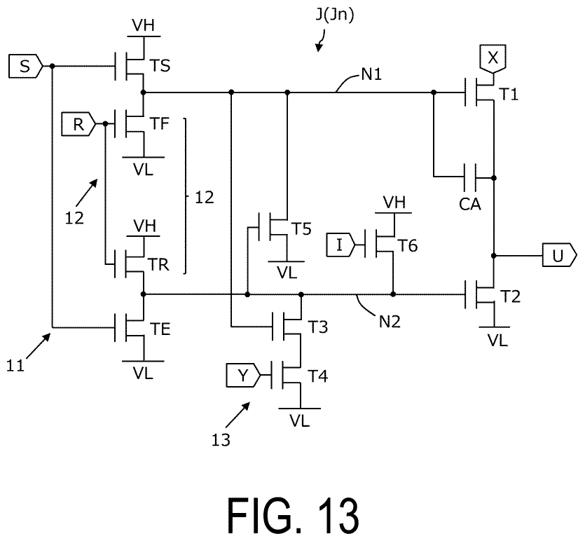

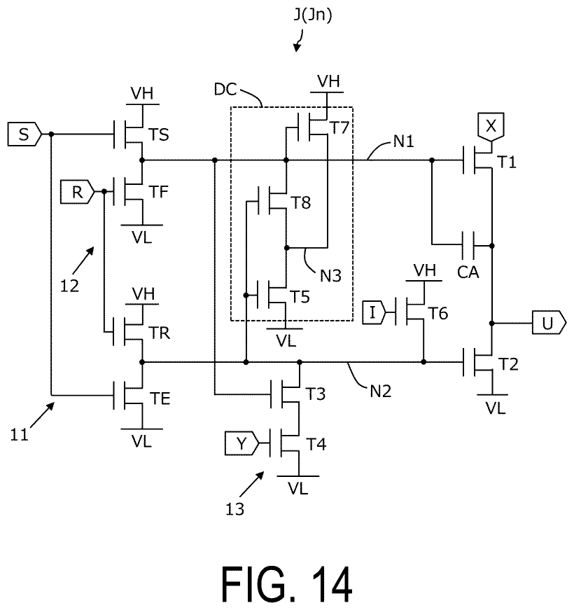

In the shift register 10, as illustrated in FIGS. 13 and 14, the first circuit 11 may include a set auxiliary transistor TE having a gate terminal S to which the set signal SS is input and connected to the second node N2, and the second circuit 12 may include a reset auxiliary transistor TF having a gate terminal R to which the reset signal RS is input and connected to the first node N1. In this manner, the second node N2 can be rapidly charged to a “Low” potential during a set operation, and the first node N1 can be rapidly charged to a “Low” potential during a reset operation. The channel width of the reset auxiliary transistor TF may be smaller than the channel width of the reset transistor TR.

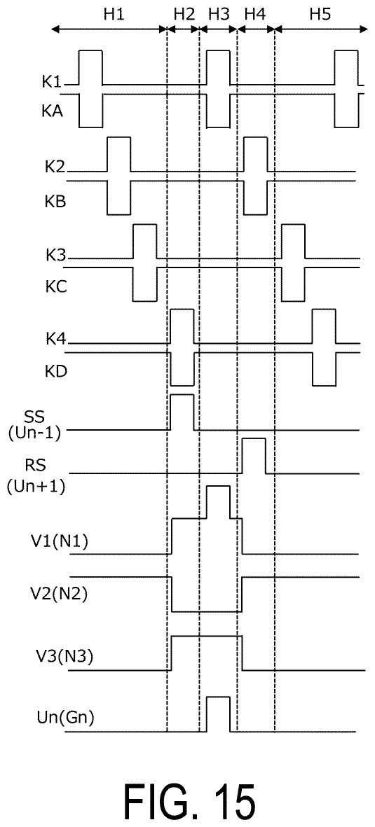

FIG. 15 is a timing chart illustrating the operation of this shift register. As illustrated in FIGS. 14 and 15, the unit circuit J of the shift register 10 may include a seventh transistor T7 having a gate terminal connected to the first node N1, an eighth transistor T8 having a gate terminal connected to the second node N2, and a third node N3. The third node N3 may be connected to a first power supply VL via the fifth transistor T5, the third node N3 may be connected to the second power supply VH via the seventh transistor T7, and the third node N3 may be connected to the first node N1 via the eighth transistor T8. The fifth transistor and the seventh and eighth transistors T7 and T8 may configure an active detection circuit DC.

As illustrated in FIG. 15, in a period H2, when the potential V1 of the first node N1 is set to “High”, the seventh transistor T7 is turned on, and a potential V3 of the third node N3 is set to “High”. In a period H4, when the potential V2 of the second node N2 is set to “High”, the fifth and eighth transistors T5 and T8 are turned on, and the potentials V1 and V3 of the first node N1 and the third node N3 are set to “Low”. In the active detection circuit DC, the activation of the first node N1 (a rise in the potential V1 of N1) and the activation of the third node N3 (a rise in the potential V3 of N3) are synchronized, and thus it is possible to detect the activation of the first node N1.

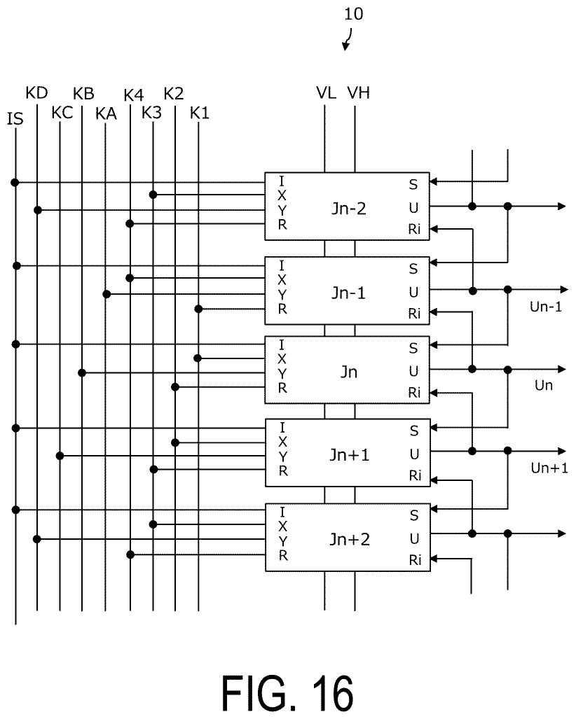

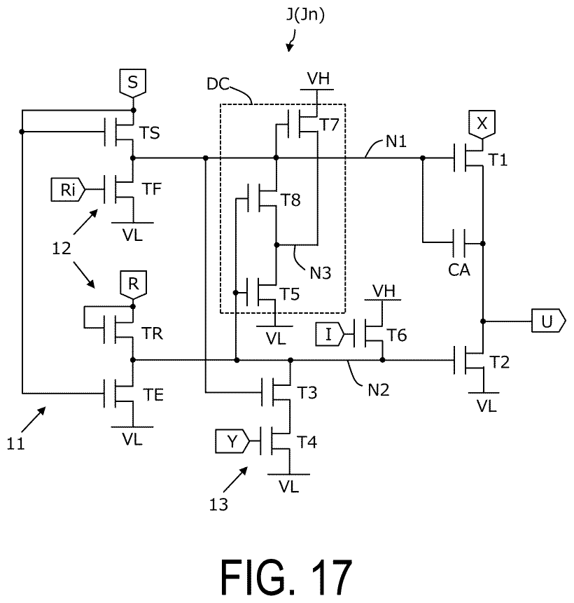

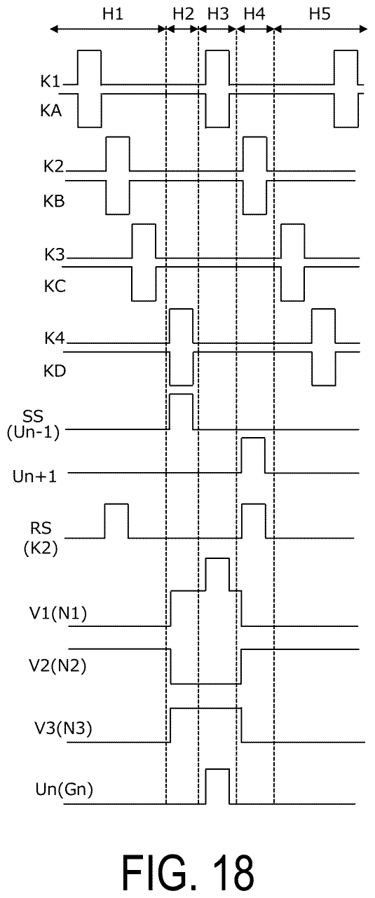

FIG. 16 is a block diagram illustrating the configuration of this shift register. FIG. 17 is a circuit diagram illustrating the configuration of a unit stage in FIG. 16. FIG. 18 is a timing chart illustrating the operation of this shift register. As illustrated in FIGS. 16 to 18, in the unit stage Jn of the shift register 10, the gate terminal (terminal R) of the reset transistor TR may be connected to one conduction terminal of the reset transistor TR, the clock signal K2 may be input to the terminal R as a reset signal, and the output signal Un+1 in the next stage may be input to the gate terminal (terminal Ri) of the reset auxiliary transistor TF as an auxiliary reset signal. The second node N2 may be connected to the terminal R via the reset transistor TR, and may be connected to the first power supply VL via the set auxiliary transistor TE.

In the unit circuit Jn in FIG. 17, the gate terminal (terminal S) of the set transistor TS may be connected to one conduction terminal of the set transistor TS, and the output signal Un−1 in the previous stage may be input to the terminal S as a set signal. The first node N1 may be connected to the first power supply VL via the reset auxiliary transistor TF. The clock signal K1 may be input to the terminal X (input terminal), the initialization signal IS may be input to the terminal I, and the clock signal KB may be input to the terminal Y as a control signal ZS.

As illustrated in FIGS. 16 to 18, the clock signal K2 including a rise-type pulse synchronized with the pulse of the output signal Un+1 in the next stage can be used as a reset signal to be input to the gate terminal (terminal R) of the reset transistor TR.

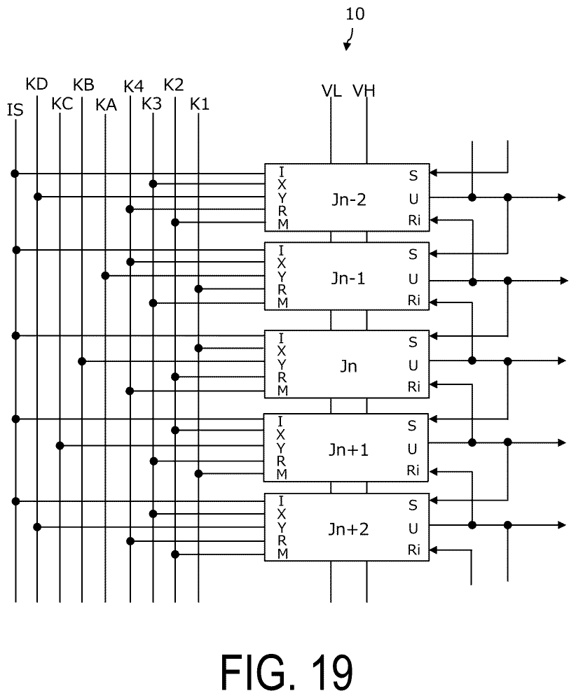

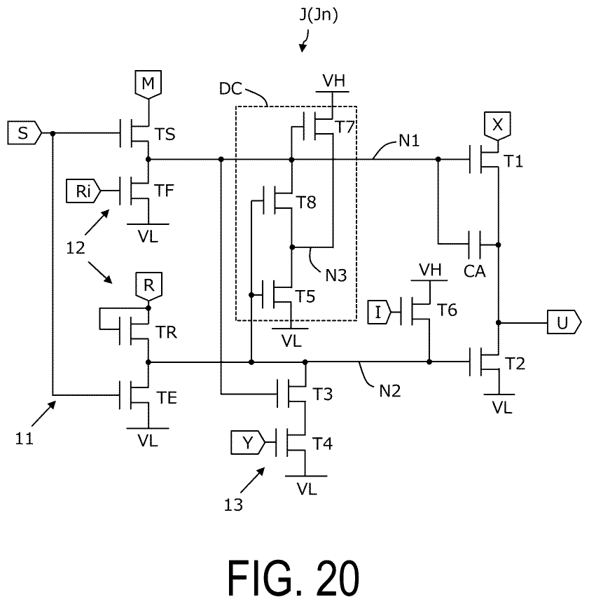

FIG. 19 is a block diagram illustrating the configuration of this shift register. FIG. 20 is a circuit diagram illustrating the configuration of a unit stage in FIG. 19. The operation of this shift register is as illustrated in FIG. 18. As illustrated in FIGS. 19 and 20, in the unit stage Jn of the shift register 10, the gate terminal (terminal R) of the reset transistor TR may be connected to one conduction terminal of the reset transistor TR, the clock signal K2 may be input to the terminal R as a reset signal, and the output signal Un+1 in the next stage may be input to the gate terminal (terminal Ri) of the reset auxiliary transistor TF as an auxiliary reset signal. The second node N2 may be connected to the terminal R via the reset transistor TR, and may be connected to the first power supply VL via the set auxiliary transistor TE.

In the unit circuit Jn in FIG. 20, the output signal Un−1 in the previous stage may be input to the gate terminal (terminal S) of the set transistor TS, and the clock signal K4 may be input to one conduction terminal (terminal M) of the set transistor TS. The first node N1 is connected to the terminal M via the set transistor TS. The clock signal K1 may be input to the terminal X (input terminal), the initialization signal IS may be input to the terminal I, and the clock signal KB may be input to the terminal Y as a control signal ZS.

As illustrated in FIGS. 19 and 20, the clock signal K4 including a rise-type pulse synchronized with the pulse of the output signal Un−1 in the previous stage can be input to the conduction terminal (terminal M) of the set transistor TS (see FIG. 18).

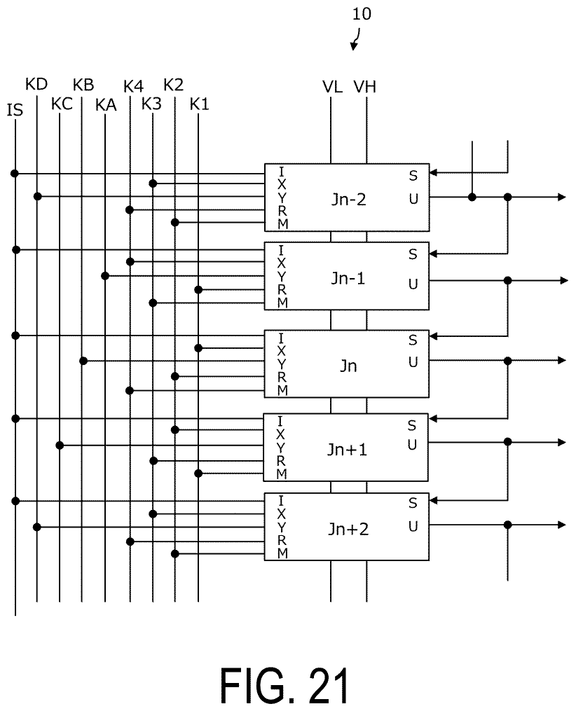

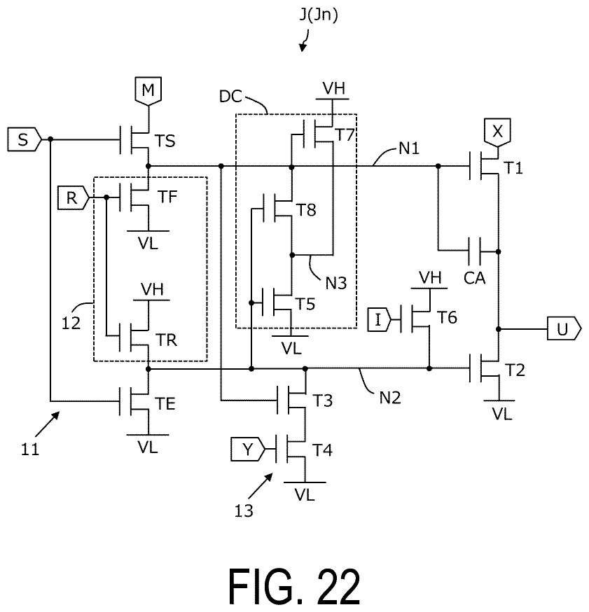

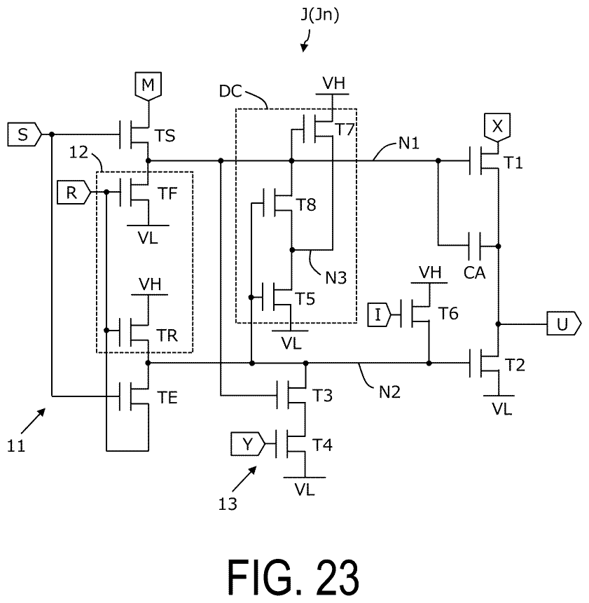

FIG. 21 is a block diagram illustrating the configuration of this shift register. FIGS. 22 and 23 are circuit diagrams illustrating the configuration of a unit stage in FIG. 20. The operation of this shift register is as illustrated in FIG. 18. As illustrated in FIGS. 21 to 23, in the unit stage Jn of the shift register 10, the gate terminal (terminal R) of the reset transistor TR may be connected to the gate terminal of the reset auxiliary transistor TF, and the clock signal K2 may be input to the terminal R as a reset signal.

In the unit circuit Jn in FIGS. 22 and 23, the output signal Un−1 in the previous stage may be input to the gate terminal (terminal S) of the set transistor TS, and the clock signal K4 may be input to one conduction terminal (terminal M) of the set transistor TS. The first node N1 is connected to the terminal M via the set transistor TS. The clock signal K1 may be input to the terminal X (input terminal), the initialization signal IS may be input to the terminal I, and the clock signal KB may be input to the terminal Y as a control signal ZS.

The second node N2 is connected to the second power supply VH via the reset transistor TR. Furthermore, the second node N2 may be connected to the first power supply VL via the set auxiliary transistor TE (see FIG. 22), or may be connected to the terminal R via the set auxiliary transistor TE (see FIG. 23). This is because the clock signal K2 input to the terminal R is set to a “Low” potential when the set signal (output signal Un−1 in the previous stage) is in an active state (see FIG. 18).

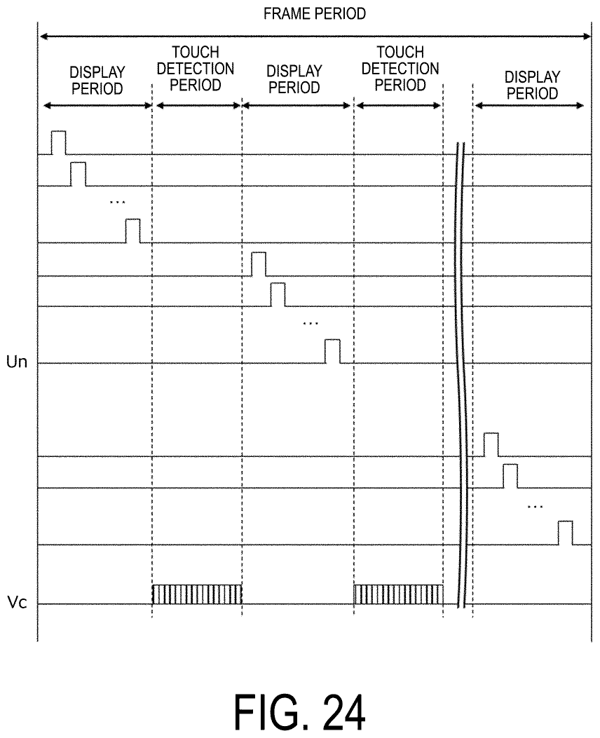

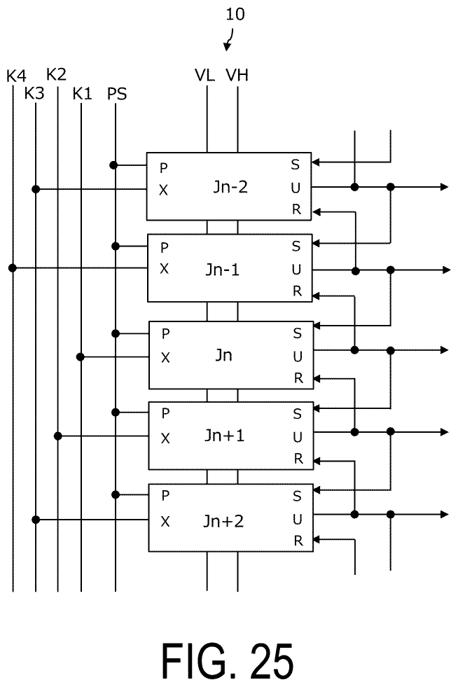

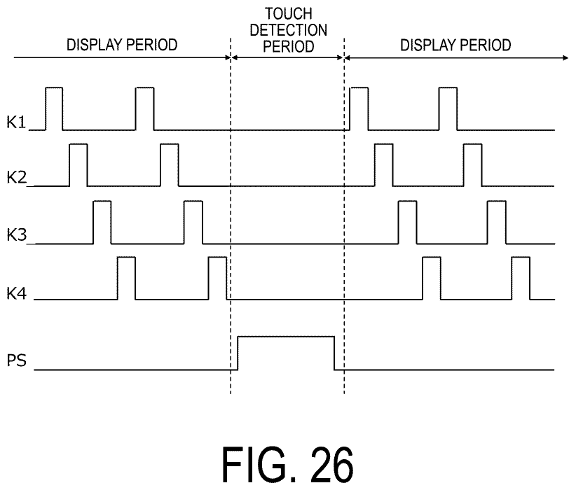

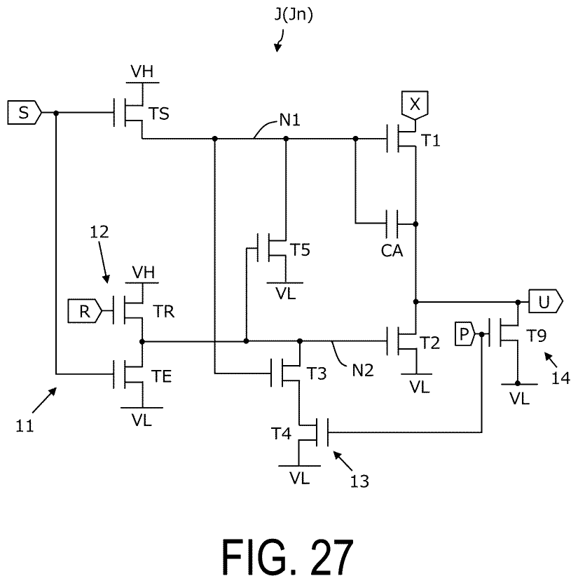

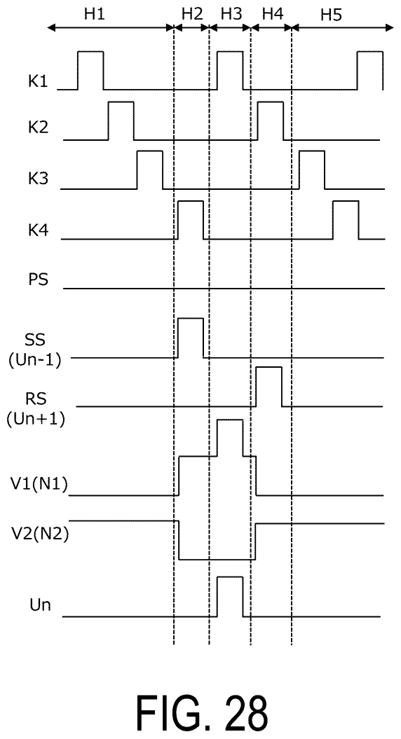

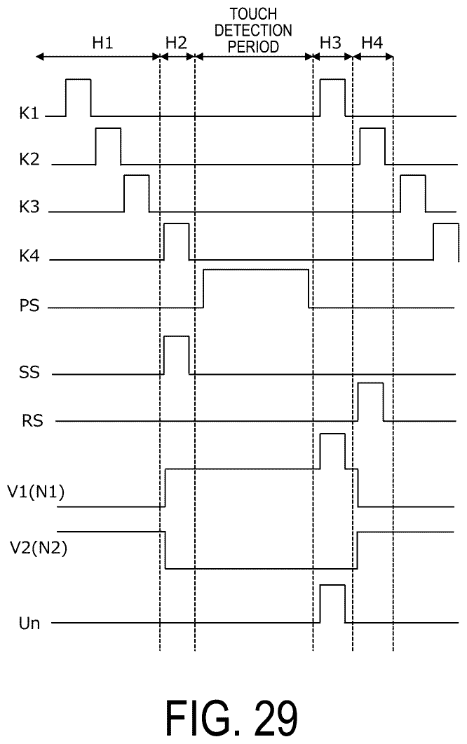

FIG. 24 is a timing chart illustrating the operation of a display device that performs touch detection. FIG. 25 is a block diagram illustrating the configuration of this shift register. FIG. 26 is a timing chart illustrating a plurality of input signals for this shift register. FIG. 27 is a circuit diagram illustrating the configuration of a unit stage in FIG. 25. FIGS. 28 and 29 are timing charts illustrating the operation of this shift register. As illustrated in FIGS. 24 to 29, in the display device 20, a touch detection period can be inserted into a display period. In this case, a touch position can be detected by controlling the potential Vc of each of a plurality of counter electrodes CE illustrated in FIG. 8.

A unit circuit Jn illustrated in FIG. 27 includes a fourth circuit (output fixing circuit) 14 connected to the output terminal U, and a switching signal PS that is set to be in an active (High) state during at least a part of a touch detection period may be input to the fourth circuit 14.

The fourth circuit 14 may fix the output terminal U to the potential of the first power supply VL while the switching signal PS is in an active period. The fourth circuit 14 may include a ninth transistor T9, the switching signal PS may be input to a control terminal (terminal P) of the ninth transistor T9, and the output terminal U may be connected to the first power supply VL via the ninth transistor T9.

As illustrated in FIG. 27, the switching signal PS may be input to the third circuit 13 (for example, the gate terminal of the fourth transistor T4) as a control signal ZS. The control signal ZS may turn off the fourth transistor T4 during a shift operation period (for example, a display period) and turn on the fourth transistor T4 during a shift stop period (for example, a touch detection period).

As illustrated in FIGS. 26 and 28, the phase of the clock signal K2 is delayed by 1H (horizontal scanning period) relative to the phase of the clock signal K1, the phase of the clock signal K3 is delayed by 1H relative to the phase of the clock signal K2, and the phase of the clock signal K4 is delayed by 1H relative to the phase of the clock signal K3. An active period (pulse width) of each clock signal may be 1H or less.

As illustrated in FIGS. 25 and 27, in the unit circuit Jn−1 in the n−1th stage, the set signal SS input to the terminal S is the output signal Un−2 in the n−2th stage, the reset signal RS input to the terminal R is the output signal Un in the nth stage, the clock signal K4 is input to the terminal X (input terminal), and the switching signal PS is input to the terminal Y as a control signal ZS. In the unit circuit Jn in the nth stage, the set signal SS input to the terminal S is the output signal Un−1 in the n−1th stage, the reset signal RS input to the terminal R is the output signal Un+1 in the n+1th stage, the clock signal K1 is input to the terminal X (input terminal), and the switching signal PS is input to the terminal Y as a control signal ZS. In the unit circuit Jn+1 in the n+1th stage, the set signal SS input to the terminal S is the output signal Un in the nth stage, the reset signal RS input to the terminal R is the output signal Un+2 in the n+2th stage, the clock signal K2 is input to the terminal X (input terminal), and the switching signal PS is input to the terminal Y as a control signal ZS.

As illustrated in FIGS. 28 and 29, the switching signal PS is at a “Low” potential during the display periods (periods H1, H2, H3, and H4). That is, during the period H4 in FIG. 28, when the reset signal RS is active high (the reset transistor TR is ON), the switching signal PS is at a “Low” potential, and the second node N2 is insulated from the first power supply VL. In other words, it is possible to avoid a problem that the first power supply VL and the second power supply VH are short-circuited via the third transistor T3 and the reset transistor TR during a reset operation (a period during which the reset transistor TR is turned on).

As illustrated in FIG. 29, during a touch detection period, the switching signal PS is at a “High” potential and the fourth transistor T4 is turned on, and thus the second node N2 can be stabilized at a “Low” potential. Furthermore, during a period in which the set signal SS (Un−1) is set to be in an active High state (the set transistor TS is turned on) in a period H2 during the display period, the set auxiliary transistor TE is turned on, and thus the second node N2 can be charged to a “Low” potential.

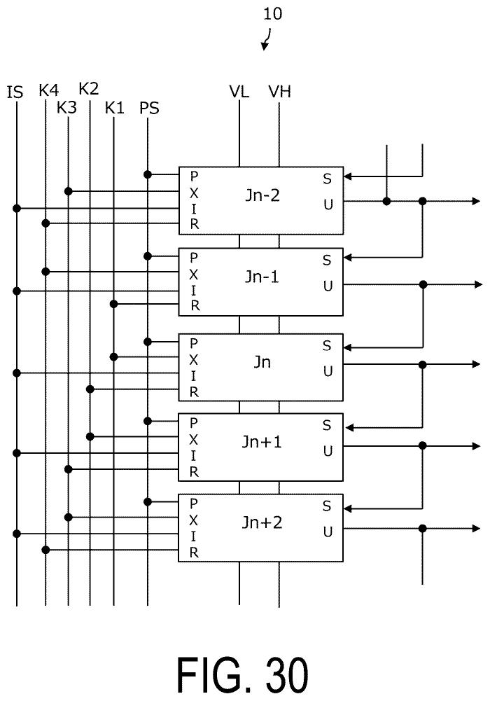

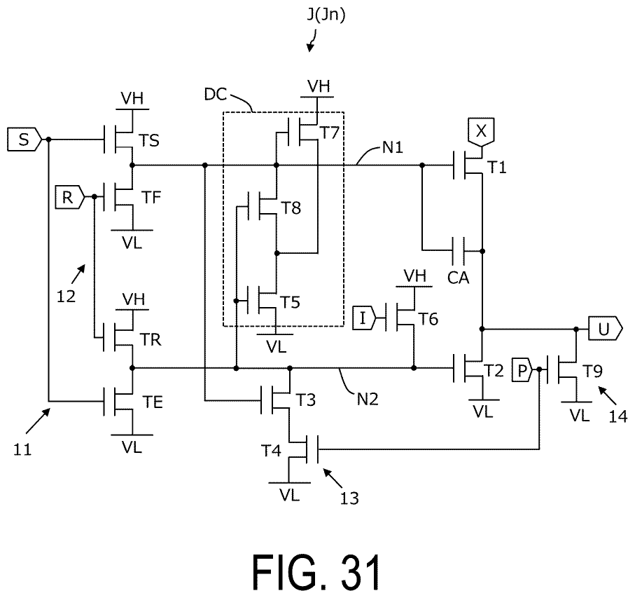

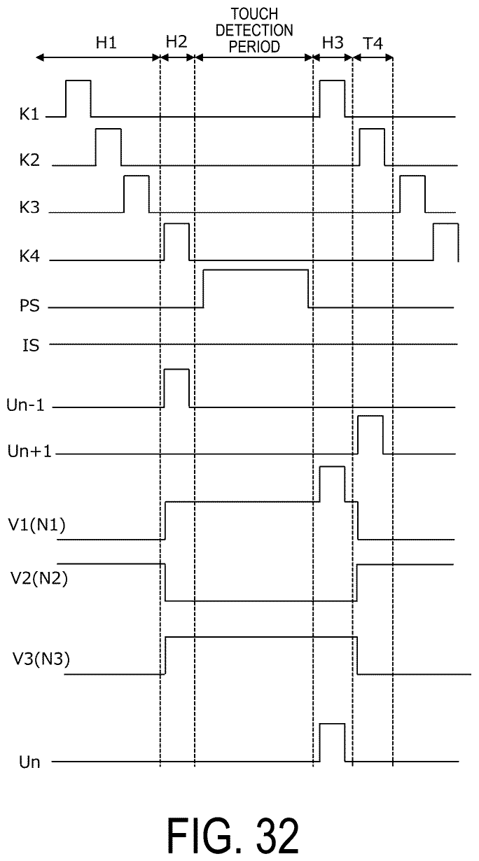

FIG. 30 is a block diagram illustrating the configuration of this shift register. FIG. 31 is a circuit diagram illustrating the configuration of a unit stage in FIG. 30. FIG. 32 is a timing chart illustrating the operation of this shift register. As illustrated in FIGS. 30 to 32, in the unit circuit Jn of the shift register 10, the output signal Un-1 in the previous stage may be input to the gate terminal (terminal S) of the set transistor TS, the second power supply VH may be connected to one conduction terminal of the set transistor TS, the clock signal K1 may be input to the terminal X (input terminal), the initialization signal IS may be input to the terminal I, and the switching signal PS may be input to the terminal Y as a control signal ZS.

The first node N1 is connected to the first power supply VL via the reset auxiliary transistor TF and connected to the second power supply VH via the set transistor TS. The second node N2 is connected to the second power supply VH via the reset transistor TR and connected to the first power supply VL via the set auxiliary transistor TE. The clock signal K2 is input to the gate terminal (terminal R) of the reset transistor TR, and the terminal R is connected to the gate terminal of the reset auxiliary transistor TF. The first and second nodes N1 and N2 may be connected to the active detection circuit DC.

During a period H4 in FIG. 32, when the reset transistor TR is turned on, the switching signal PS is at a “Low” potential, and the second node N2 is insulated from the first power supply VL. In other words, it is possible to avoid a problem that the first power supply VL and the second power supply VH are short-circuited via the third transistor T3 and the reset transistor TR during a reset operation (a period during which the reset transistor TR is turned on).

During the touch detection period in FIG. 32, the switching signal PS is at a “High” potential and the fourth transistor T4 is turned on, and thus the second node N2 can be stabilized at a “Low” potential. Furthermore, during a period in which the set signal SS (Un−1) is set to be in an active High state (the set transistor TS is turned on) in a period H2 during the display period, the set auxiliary transistor TE is turned on, and thus the second node N2 can be charged to a “Low” potential.

The above-described embodiment is for the purpose of illustration and description and is not intended to be limiting. It will be apparent to those skilled in the art that many variations will be possible in accordance with these examples and descriptions.

### Supplement

A shift register of a first aspect is a shift register including a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, and a third transistor whose gate terminal is connected to the first node, in which each of the plurality of unit circuits includes a third circuit, the second node is connected to a first power supply via the third transistor and the third circuit, and a control signal is input to the third circuit.

In a shift register of a second aspect according to the shift register of the first aspect, the third circuit includes a fourth transistor, the second node is connected to the first power supply via the third transistor and the fourth transistor, and the control signal is input to a gate terminal of the fourth transistor.

In a shift register of a third aspect according to the shift register of the first or second aspect, the fourth transistor is turned off by the control signal during an active period of the reset signal.

In a shift register of a fourth aspect according to the shift register of any one of the first to third aspects, the control signal and the reset signal are in an opposite phase relationship during an active period of the reset signal.

In a shift register of a fifth aspect according to the shift register of the second aspect, the fourth transistor is turned on by the control signal during an active period of the set signal.

In a shift register of a sixth aspect according to the shift register of any one of the first to fifth aspects, each of the plurality of unit circuits includes an output terminal connected to one conduction terminal of the first transistor and one conduction terminal of the second transistor.

In a shift register of a seventh aspect according to the shift register of any one of the first to sixth aspects, clock signals of a plurality of phases are input to the plurality of unit circuits, one of the clock signals of the plurality of phases is input to the other conduction terminal of the first transistor, and the other conduction terminal of the second transistor is connected to the first power supply.

In a shift register of an eighth aspect according to the shift register of the seventh aspect, the control signal is another one of the clock signals of the plurality of phases.

In a shift register of a ninth aspect according to the shift register of any one of the first to eighth aspects, the reset signal is an output of a unit circuit located following the current stage.

In a shift register of a tenth aspect according to the shift register of the seventh aspect, the reset signal is another one of the clock signals of the plurality of phases.

In a shift register of an eleventh aspect according to the shift register of any one of the first to tenth aspects, each of the plurality of unit circuits includes a fifth transistor having a gate terminal connected to the second node, and
the first node is connected to the first power supply via the fifth transistor.

In a shift register of a twelfth aspect according to the shift register of any one of the first to eleventh aspects, each of the plurality of unit circuits includes a capacitance element, and one conduction terminal of the first transistor is connected to a gate terminal of the first transistor via the capacitance element.

In a shift register of a thirteenth aspect according to the shift register of any one of the first to twelfth aspects, the first circuit and the second circuit are each connected to a second power supply.

In a shift register of a fourteenth aspect according to the shift register of any one of the first to thirteenth aspects, each of the plurality of unit circuits includes a sixth transistor having a gate terminal to which an initialization signal is input, and the second node is connected to a second power supply via the sixth transistor.

In a shift register of a fifteenth aspect according to the shift register of any one of the first to fourteenth aspects, the first circuit includes a set transistor to which the set signal is input and which is connected to a first node, and the second circuit includes a reset transistor to which the reset signal is input and which is connected to a second node.

In a shift register of a sixteenth aspect according to the shift register of any one of the first to fifteenth aspects, the first circuit includes a set auxiliary transistor to which the set signal is input and which is connected to a second node, and the second circuit includes a reset auxiliary transistor to which the reset signal is input and which is connected to a first node.

In a shift register of a seventeenth aspect according to the shift register of any one of the first to sixteenth aspects, each of the plurality of unit circuits includes a seventh transistor having a gate terminal connected to the first node, an eighth transistor having a gate terminal connected to the second node, and a third node, in which the third node is connected to the first power supply via the fifth transistor, the third node is connected to a second power supply via the seventh transistor, and the third node is connected to the first node via the eighth transistor.

In a shift register of an eighteenth aspect according to the shift register of the sixth aspect, each of the plurality of unit circuits includes a fourth circuit connected to the output terminal, and a switching signal that is set to be in an active state during at least a part of a touch detection period is input to the fourth circuit.

In a shift register of a nineteenth aspect according to the shift register of the eighteenth aspect, the fourth circuit fixes the output terminal to the potential of the first power supply during a period in which the switching signal is in an active state.

In a shift register of a twentieth aspect according to the shift register of the eighteenth aspect, the switching signal is input to the third circuit as the control signal.

In a shift register of a 21st aspect according to the shift register of the second aspect, the control signal turns off the fourth transistor during a shift operation period and turns on the fourth transistor during a shift stop period.

In a shift register of a 22nd aspect according to the shift register of the seventeenth aspect, the shift register is provided in a display device equipped with a touch sensor, and the shift stop period is a touch detection period.

In a shift register of a 23rd aspect according to the shift register of any one of the first to 22nd aspects, the first to third transistors are n-channel types, and the first power supply is a low-potential side power supply.

A display device of a 24th aspect includes the shift register of any one of the first to 23rd aspects.

A method of a 25th aspect is a method of driving a shift register including a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, a third transistor whose gate terminal is connected to the first node, and a fourth transistor, and the second node being connected to a first power supply via the third transistor and the fourth transistor, in which the fourth transistor is turned off during an active period of the reset signal.

In a method of driving a shift register of a 26th aspect according to the method of driving a shift register of the 25th aspect, the fourth transistor is turned off during a shift operation period, and the fourth transistor is turned on during a shift stop period.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A shift register comprising:
a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, and a third transistor whose gate terminal is connected to the first node,
wherein each of the plurality of unit circuits includes a third circuit,
the second node is connected to a first power supply via the third transistor and the third circuit, and
a control signal is input to the third circuit.

2. The shift register according to claim 1,
wherein the third circuit includes a fourth transistor,
the second node is connected to the first power supply via the third transistor and the fourth transistor, and
the control signal is input to a gate terminal of the fourth transistor.

3. The shift register according to claim 2,
wherein the fourth transistor is turned off by the control signal during an active period of the reset signal.

4. The shift register according to claim 2,
wherein the control signal and the reset signal are in an opposite phase relationship during an active period of the reset signal.

5. The shift register according to claim 2,
wherein the fourth transistor is turned on by the control signal during an active period of the set signal.

6. The shift register according to claim 1,
wherein each of the plurality of unit circuits includes an output terminal connected to one conduction terminal of the first transistor and one conduction terminal of the second transistor.

7. The shift register according to claim 6,
wherein clock signals of a plurality of phases are input to the plurality of unit circuits,
one of the clock signals of the plurality of phases is input to another conduction terminal of the first transistor, and
another conduction terminal of the second transistor is connected to the first power supply.

8. The shift register according to claim 7,
wherein the control signal is another one of the clock signals of the plurality of phases.

9. The shift register according to claim 1,
wherein the reset signal is an output of a unit circuit located following the current stage.

10. The shift register according to claim 7,
wherein the reset signal is another one of the clock signals of the plurality of phases.

11. The shift register according to claim 1,
wherein each of the plurality of unit circuits includes a fifth transistor including a gate terminal connected to the second node, and
the first node is connected to the first power supply via the fifth transistor.

12. The shift register according to claim 1,
wherein each of the plurality of unit circuits includes a sixth transistor including a gate terminal to which an initialization signal is input, and
the second node is connected to a second power supply via the sixth transistor.

13. The shift register according to claim 1,
wherein the first circuit includes a set transistor to which the set signal is input and which is connected to a first node, and
the second circuit includes a reset transistor to which the reset signal is input and which is connected to a second node.

14. The shift register according to claim 13,
wherein the first circuit includes a set auxiliary transistor to which the set signal is input and which is connected to a second node, and
the second circuit includes a reset auxiliary transistor to which the reset signal is input and which is connected to a first node.

15. The shift register according to claim 11,
wherein each of the plurality of unit circuits includes a seventh transistor including a gate terminal connected to the first node, an eighth transistor including a gate terminal connected to the second node, and a third node,
the third node is connected to the first power supply via the fifth transistor,
the third node is connected to a second power supply via the seventh transistor, and
the third node is connected to the first node via the eighth transistor.

16. The shift register according to claim 6,
wherein each of the plurality of unit circuits includes a fourth circuit connected to the output terminal,
a switching signal that is set to be in an active state during at least a part of a touch detection period is input to the fourth circuit,
the fourth circuit fixes the output terminal to a potential of the first power supply during a period in which the switching signal is in an active state, and
the switching signal is input to the third circuit as the control signal.

17. The shift register according to claim 2,
wherein the control signal turns off the fourth transistor during a shift operation period and turns on the fourth transistor during a shift stop period.

18. The shift register according to claim 17,
wherein the shift register is provided in a display device equipped with a touch sensor, and
the shift stop period is a touch detection period.

19. A display device comprising:
the shift register according to claim 1.

20. A method of driving a shift register comprising:
a plurality of unit circuits, each of the plurality of unit circuits including a first circuit to which a set signal is input, a second circuit to which a reset signal is input, a first transistor, a second transistor, a first node connected to a gate terminal of the first transistor, a second node connected to a gate terminal of the second transistor, a third transistor whose gate terminal is connected to the first node, and a fourth transistor, the second node being connected to a first power supply via the third transistor and the fourth transistor,
wherein the fourth transistor is turned off during an active period of the reset signal.
